(19) United States
(12) Patent Application Publication
(10) Pub. No.: US 2009/0058767 A1
(43) Pub. Date: Mar. 5, 2009

(54) PLASMA DISPLAY DEVICE

(75) Inventors: Ki Rack PARK, Gumi-si (KR); Jong Woon BAE, Gumi-si (KR); Seong Hwan RYU, Gumi-si (KR)

Correspondence Address: FISH & RICHARDSON P.C., P.O. BOX 1022, MINNEAPOLIS, MN, 55440-1022, US

(73) Assignee: LG ELECTRONICS INC., Seoul (KR)

(21) Appl. No.: 12/200,192

(22) Filed: Aug. 28, 2008

(30) Foreign Application Priority Data
Aug. 29, 2007 (KR) 10-2007-0087229
May 1, 2008 (KR) 10-2008-0041038

(51) Int. Cl. G09G 3/28

(52) U.S. Cl. 345/60

(57) ABSTRACT

There is provided a plasma display device including a plasma display panel (PDP). A unit frame of the PDP is divided into a plurality of subfields to be driven. A reset signal supplied to the scan electrodes in at least one subfield among the plurality of subfields includes a first period in which a first voltage is supplied, a second period in which a second voltage lower than the first voltage is supplied, and a third period in which a voltage is gradually reduced. A third positive voltage is supplied to the sustain electrodes in the second period. In the reset period for initializing the wall charges formed in the electrodes, low voltage small width signals are supplied to the scan electrodes to erase the positive polar wall charges formed in the scan electrodes so that the generation of the brilliant point can be prevented and that the driving margin of the PDP can be secured. In addition, after the wall charges are erased, a positive polar voltage is supplied to the scan electrodes and the sustain electrodes to form the negative polar charges in the discharge space on the electrodes so that a voltage margin for the address discharge and the sustain discharge is secured and that the discharge can be stabilized.

### BACKGROUND OF THE INVENTION

1. Field of the Invention

The present invention relates to a plasma display device, and more particularly, to the waveforms of driving signals supplied to a plasma display panel (PDP).

2. Discussion of the Related Art

A plasma display panel (PDP) excites a phosphor by vacuum ultraviolet rays (VUV) generated when mixtures of inert gases are discharged to emit light and to display an image.

The PDP can be easily made large, thin, and simple so that the PDP can be easily manufactured and has higher brightness and emission efficiency than other flat panel displays (FPD). In particular, since an alternate current (AC) surface discharge type three electrode PDP has wall charges accumulated on the surface thereof during discharge to protect electrodes from sputtering generated by the discharge, the AC surface discharge type three electrode PDP is driven at a low voltage and has a long life.

The PDP is time division driven in a reset period for initializing all of the cells, an address period for selecting a cell, and a sustain period for generating display discharge in the selected cell in order to realize the gray levels of an image.

In the reset period, when strong discharge is generated among electrodes, brilliant spots are generated to deteriorate the contrast of a display image.

In addition, in the reset period, when all of the discharge cells are not initialized to a wall charge state for addressing, erroneous discharge can be generated or discharge may not be generated in the address period or the sustain period so that the quality of a display image can deteriorate.

### SUMMARY OF THE INVENTION

In order to solve the above-described problems, it is an object of the present invention to provide a plasma display device capable of preventing brilliant spots from being generated in a reset period and of stably initializing all of the discharge cells.

In order to achieve the above object, the plasma display device according to the present invention includes a plasma display device including a plasma display panel (PDP) including a plurality of scan electrodes and sustain electrodes formed on an upper substrate and a plurality of address electrodes formed on a lower substrate; and a driving unit for supplying driving signals to the plurality of electrodes. A unit frame of the PDP is divided into a plurality of subfields to be driven. A reset signal supplied to the scan electrodes in at least one subfield among the plurality of subfields includes a first period in which a first voltage is supplied, a second period in which a second voltage lower than the first voltage is supplied, and a third period in which a voltage is gradually reduced. A third positive voltage is supplied to the sustain electrodes in the second period.

### BRIEF DESCRIPTION OF THE DRAWINGS

FIG. 1 is a perspective view illustrating the structure of a plasma display panel (PDP) according to an embodiment of the present invention;

FIG. 2 is a sectional view illustrating the arrangement of the electrodes of the PDP according to an embodiment of the present invention;

FIG. 3 is a timing diagram illustrating a method of dividing one frame into a plurality of subfields to time division drive the PDP according to an embodiment of the present invention;

FIG. 4 is a timing diagram illustrating driving signals for driving the PDP according to an embodiment of the present invention;

FIG. 5 is a timing diagram illustrating driving signals for driving the PDP according to another embodiment of the present invention;

FIG. 6 is a graph illustrating the results of experiments on a relationship among the Xe mixture ratio, the discharge efficiency, and the discharge start voltage of a discharge gas;

FIGS. 7 to 14 are timing diagrams illustrating the waveforms of reset signals according to embodiments of the present invention;

FIG. 15 is a sectional view illustrating the structure of the upper substrate of the PDP according to an embodiment of the present invention;

FIG. 16 is a sectional view illustrating the structure of the electrodes of the upper substrate of the PDP according to an embodiment of the present invention; and

FIG. 17 is a sectional view illustrating the structure of an external light shielding sheet provided on the front surface of the PDP according to an embodiment of the present invention.

### DETAILED DESCRIPTION OF THE PREFERRED EMBODIMENTS

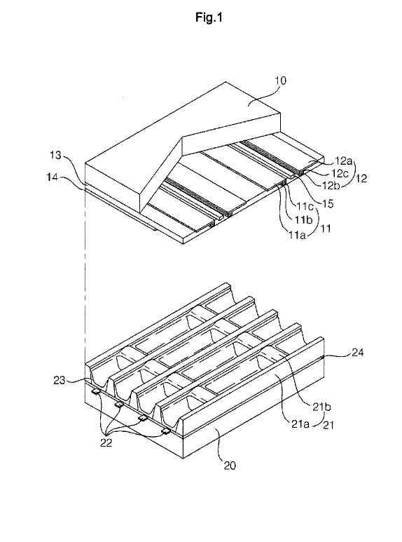

Hereinafter, a plasma display device according to the present invention will be described in detail with reference to the accompanying drawings. FIG. 1 is a perspective view illustrating the structure of a plasma display panel (PDP) according to an embodiment of the present invention.

As illustrated in FIG. 1, the PDP includes scan electrodes 11 and sustain electrodes 12 that are pairs of sustain electrodes formed on an upper substrate 10 and address electrodes 22 formed on a lower substrate 20.

The pairs of sustain electrodes 11 and 12 commonly include transparent electrodes 11a and 12a and bus electrodes 11b and 12b formed of indium tin oxide (ITO). The bus electrodes 11b and 12b can be formed of metal such as Ag and Cr, a lamination of Cr/Cu/Cr, or a lamination of Cr/Al/Cr. The bus electrodes 11b and 12b are formed on the transparent electrodes 11a and 12a to reduce reduction in a voltage that is caused by the transparent electrodes 11a and 12a having high resistance.

On the other hand, according to an embodiment of the present invention, the pairs of sustain electrodes 11 and 12 can be formed of only the bus electrodes 11b and 12b without the transparent electrodes 11a and 12a as well as a lamination of the transparent electrodes 11a and 12a and the bus electrodes 11b and 12b. In such a structure, since the transparent electrodes 11a and 12a are not used, the cost of manufacturing the PDP can be reduced. The bus electrodes 11b and 12b used for the structure can be formed of various materials such as a photosensitive material other than the above mentioned materials.

Black matrixes BM 15 having a light shielding function of absorbing external light generated in the outside of the upper substrate 10 to reduce reflection and a function of improving the purity and contrast of the upper substrate 10 are provided between the transparent electrodes 11a and 12a and the bus electrodes 11b and 11c of the scan electrodes 11 and the sustain electrodes 12.

The black matrixes 15 according to an embodiment of the present invention are formed on the upper substrate 10 and can consist of first black matrixes 15 formed to overlap barrier ribs 21 and second black matrixes 11c and 12c formed between the transparent electrodes 11a and 12a and the bus electrodes 11b and 12b. Here, the first black matrixes 15 and the second black matrixes 11c and 12c referred to as a black layer or a black electrode layer can be simultaneously formed to be physically connected to each other and may not be simultaneously formed not to be physically connected to each other.

In addition, when the first black matrixes 15 and the second black matrixes 11c and 12c are physically connected to each other, the first black matrixes 15 and the second black matrixes 11c and 12c are formed of the same material. However, when the first black matrixes 15 and the second black matrixes 11c and 12c are physically separated from each other, the first black matrixes 15 and the second black matrixes 11c and 12c can be formed of different materials.

An upper dielectric layer 13 and a protective layer 14 are laminated on the upper substrate 10 where the scan electrodes 11 and the sustain electrodes 12 run parallel to each other. Charged particles generated by discharge are accumulated on the upper dielectric layer 13 to protect the pairs of sustain electrodes 11 and 12. The protective layer 14 protects the upper dielectric layer 13 against the sputtering of the charged particles generated during gas discharge and improves the emission efficiency of secondary electrons.

In addition, the address electrodes 22 are formed to intersect the scan electrodes 11 and the sustain electrodes 12. In addition, a lower dielectric layer 24 and the barrier ribs 21 are formed on the lower substrate 20 where the address electrodes 22 are formed.

In addition, phosphor layers 23 are formed on the surfaces of the lower dielectric layer 24 and the barrier ribs 21. The barrier ribs 21 in which vertical barrier ribs 21a and horizontal barrier ribs 21b are formed to be closed physically divide discharge cells from each other and prevent the ultraviolet (UV) rays and visible rays generated by discharge from leaking to adjacent discharge cells.

According to an embodiment of the present invention, the barrier ribs 21 can have various structures as well as the structure illustrated in FIG. 1. For example, the barrier ribs 21 can have a differential barrier rib structure in which the height of the vertical barrier ribs 21a is different from the height of the horizontal barrier ribs 21b, a channel type barrier rib structure in which a channel that can be used as an exhaust path is formed in at least one of the vertical barrier ribs 21a and the horizontal barrier ribs 21b, and a hollow type barrier rib structure in which a hollow is formed in at least one of the vertical barrier ribs 21a and the horizontal barrier ribs 21b.

Here, in the differential barrier rib structure, the height of the horizontal barrier ribs 21b is preferably higher than the height of the vertical barrier ribs 21a. In the channel type barrier rib structure or the hollow type barrier rib structure, the channel or the hollow is preferably formed in the horizontal barrier ribs 21b.

On the other hand, according to an embodiment of the present invention, it is described that R, G, and B discharge cells are arranged on the same line, however, can be arranged in other forms. For example, delta type arrangement in which the R, G, and B discharge cells are triangularly arranged can be performed. In addition, the shape of the discharge cell can be various polygons such as a pentagon and a hexagon as well as a square.

In addition, the phosphor layers 23 emit light by the UV rays generated during the gas discharge to generate on visible ray among red R, green G, and blue B visible rays. Here, mixtures of inert gases such as He+Xe, Ne+Xe, and He+Ne+Xe for discharge are implanted into discharge spaces provided among the upper and lower substrates 10 and 20 and the barrier ribs 21.

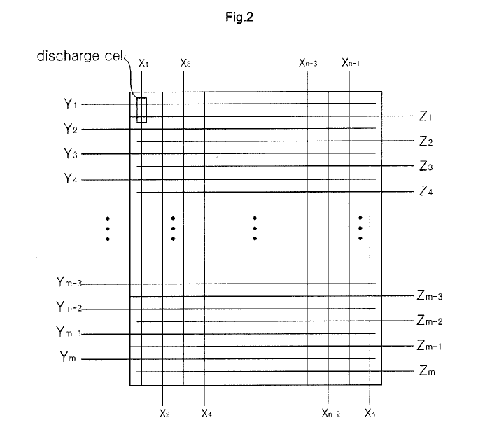

FIG. 2 is a sectional view illustrating the arrangement of the electrodes of the PDP according to an embodiment of the present invention. The plurality of discharge cells that constitute the PDP, as illustrated in FIG. 2, are preferably arranged in a matrix. The plurality of discharge cells are provided in the intersections of scan electrode lines Y1 to Ym, sustain electrode lines Z1 to Zm, and address electrode lines X1 to Xn. The scan electrode lines Y1 to Ym can be sequentially or simultaneously driven and the sustain electrode lines Z1 to Zm can be simultaneously driven. The address electrode lines X1 to Xn can be divided into odd lines and even lines to be driven or can be sequentially driven.

Since the arrangement of the electrodes illustrated in FIG. 2 is only an embodiment of the arrangement of the electrodes of the PDP according to the present invention, the present invention is not limited to the arrangement of the electrodes of the PDP illustrated in FIG. 2 and the method of driving the PDP illustrated in FIG. 2. For example, a dual scan method in which two scan electrode lines among the scan electrode lines Y1 to Ym are simultaneously scanned can be performed. In addition, the address electrode lines X1 to Xn are divided into an upper part and a lower part in the center of the PDP to be driven.

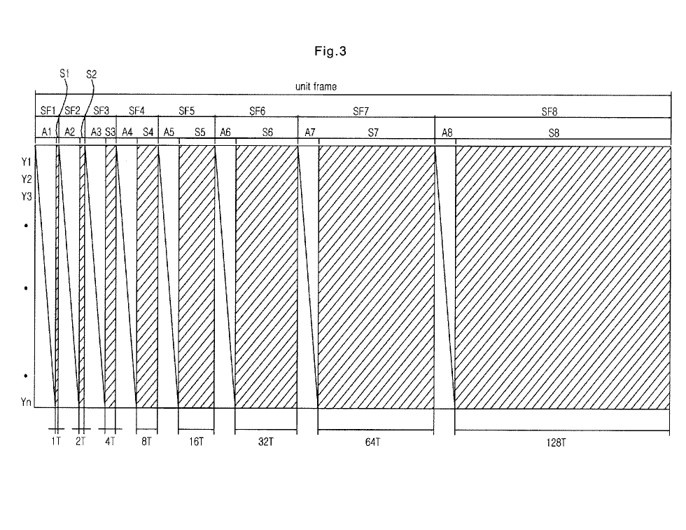

FIG. 3 is a timing diagram illustrating a method of dividing one frame into a plurality of subfields to time division drive the PDP according to an embodiment of the present invention. A unit frame can be divided into a predetermined number of, for example, eight subfields SF1, . . . , and SF8 in order to display time division gray levels. In addition, the subfields SF1, . . . , and SF8 are divided into reset periods (not shown), address periods A1, . . . , and A8, and sustain periods S1, . . . , and S8.

Here, according to an embodiment of the present invention, the reset period can be omitted from at least one of the plurality of subfields. For example, the reset period can exist only in an initial subfield or only in an intermediate subfield among all of the subfields.

In the address periods A1, . . . , and A8, display data signals are applied to the address electrodes X and scan pulses corresponding to the scan electrodes Y are sequentially applied.

In the sustain periods S1, . . . , and S8, sustain pulses are alternately applied to the scan electrodes Y and the sustain electrodes Z to generate sustain discharge by the discharge cells where wall charges are formed in the address periods A1, . . . , and A8.

The brightness of the PDP is in proportion to the number of sustain discharge pulses in the sustain discharge periods S1, . . . , and S8 occupied in the unit frame. When one frame that forms an image is displayed into the eight subfields and 256 gray levels, different numbers of sustain pulses can be sequentially assigned to the subfields in the ratio of 1, 2, 4, 8, 16, 32, 64, and 128. In order to obtain the brightness of 133 gray levels, cells are addressed in a subfield 1 period, a subfield 3 period, and a subfield 8 period to perform the sustain discharge.

The number of sustain discharges assigned to the subfields can be variably determined in accordance with the weight value of the subfields in accordance with an automatic power control (APC) step. That is, in FIG. 3 one frame is divided into the eight subfields. However, the present invention is not limited thereto and the number of subfields that constitute one frame can vary in accordance with a design. For example, one frame can be divided into no less than the eight subfields such as 12 or 16 subfields to drive the PDP.

In addition, the number of sustain discharges assigned to the subfields can vary in consideration of a gamma characteristic or a panel characteristic. For example, the degree of gray levels assigned to the subfield 4 can be reduced from 8 to 6 and the degree of gray levels assigned to the subfield 6 can be increased from 32 to 34.

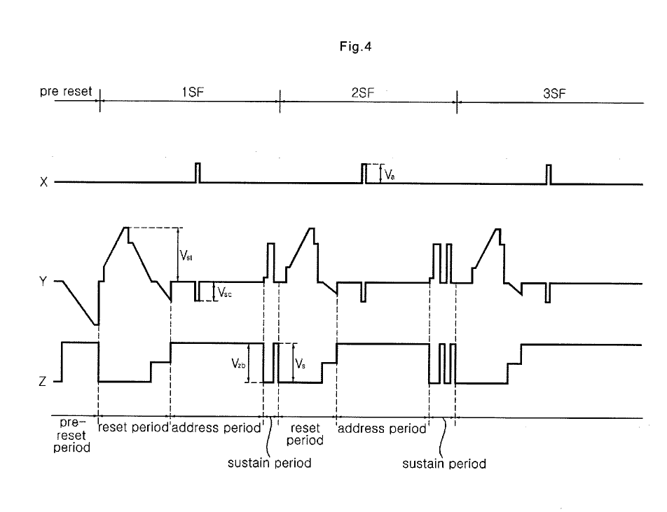

FIG. 4 is a timing diagram illustrating driving signals for driving the PDP according to an embodiment of the present invention so that the sustain periods for sustaining the discharge of the discharge cells can be included.

The subfield includes a pre-reset period for forming positive polar wall charges on the scan electrodes Y and for forming negative polar wall charges on the sustain electrodes Z, a reset period for initializing the discharge cells on the entire screen using the distribution of the wall charges formed in the pre-reset period, an address period for selecting discharge cells, and a sustain period for sustaining the discharge of the selected discharge cells.

The reset period is divided into a set up period and a set down period. In the set up period, a rising ramp waveform is simultaneously applied to all of the scan electrodes so that fine discharge is generated by all of the discharge cells and that the wall charges are generated. In the set down period, a falling ramp waveform Ramp-down that falls at a positive polar voltage lower than the peak voltage of the rising ramp waveform Ramp-up is simultaneously applied to all of the scan electrodes Y so that erase discharge is generated by all of the discharge cells and that unnecessary charges are erased among the wall charges and space charges generated by set up discharge.

In the address period, scan signals having a negative polar scan voltage Vsc are sequentially applied to the scan electrodes and, at the same time, positive polar data signals are applied to the address electrodes X. Address discharge is generated by a voltage difference between the scan signals and the data signals and a wall voltage generated in the reset period to select cells. On the other hand, in order to improve the efficiency of the address discharge, a sustain bias voltage Vzb is applied to the sustain electrodes in the address period.

In the address period, the plurality of scan electrodes Y are divided into at least two groups so that the scan signals can be sequentially supplied to the groups and each of the divided groups is divided into at least two subgroups again so that the scan signals can be sequentially supplied by the subgroups. For example, after the plurality of scan electrodes Y are divided into a first group and a second group and the scan signals are sequentially supplied to the scan electrodes that belong to the first group, the scan signals can be sequentially supplied to the scan electrodes that belong to the second group.

According to an embodiment of the present invention, the plurality of scan electrodes Y can be divided into a first even group and a second odd group in accordance with the positions where the scan electrodes Y are formed on the PDP. According to another embodiment, the scan electrodes Y can be divided into a first group positioned in the upper side and a second group positioned in the lower side based on the center of the PDP.

The scan electrodes that belong to the first group divided by the above method can be divided into a first even subgroup and a second odd subgroup or can be divided into a first subgroup positioned in the upper side and a second subgroup positioned in the lower side based on the center of the first group.

In the sustain period, the sustain pulses having the sustain voltage Vs are alternately applied to the scan electrodes and the sustain electrodes to generate the sustain discharge in the form of surface discharge between the scan electrodes and the sustain electrodes.

In the sustain period, the width of the first sustain signal or the last sustain signal among the plurality of sustain signals alternately supplied to the scan electrodes and the sustain electrodes can be larger than the width of the remaining sustain pulses.

The present invention is not limited to the waveforms illustrated in FIG. 4. For example, the pre-reset period can be omitted and the polarity and the voltage level of the driving signals illustrated in FIG. 4 can vary if necessary. In addition, single sustain driving in which the sustain signals can be applied to one of the scan electrodes Y and the sustain electrodes Z so that the sustain discharge is generated can be performed.

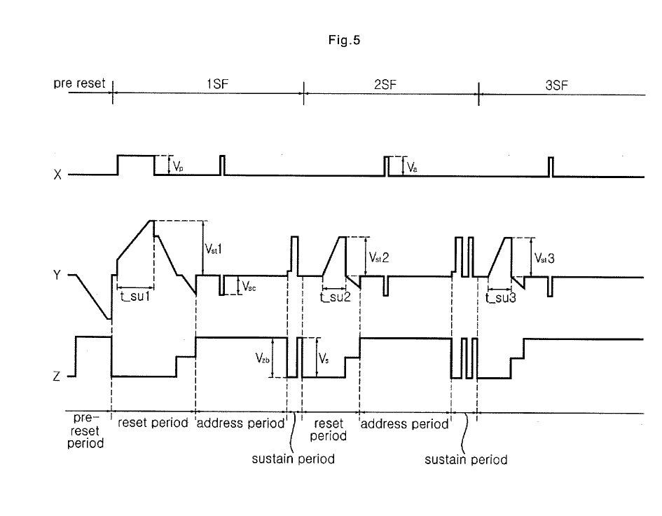

FIG. 5 illustrates the waveform of a panel driving signal according to another embodiment of the present invention. The highest voltage Ve of a reset signal supplied in one subfield of the plurality of subfields that constitute one frame can be smaller than the highest voltage Vst of a reset signal supplied in another subfield of the plurality of subfields.

For example, in a first subfield 1SF, a reset signal that rises to Vst1 is supplied to the scan electrodes Y and, in subfields 2SF to 8SF after a second subfield 2SF, reset signals that rise to Vst2 smaller than the Vst1 can be supplied to the scan electrodes Y.

In this case, the length t_su2 of the set up period of the reset signals supplied in the subfields 2SF to 8SF after the second subfield 2SF can be smaller than the length t_su1 of the set up period of the reset signal supplied in the first subfield 1SF.

As described above, the highest voltage Vst2 of the reset signals supplied in the subfields after the second subfield is reduced to secure the driving margin of the PDP so that it is advantageous to high speed driving and to reduce the power consumption for driving the PDP.

In this case, in the first subfield, initialization discharge is generated by all of the discharge cells so that negative polar (−) wall charges are formed in the scan electrodes Y and that positive polar (+) wall charges are formed in the sustain electrodes Z to initialize the wall charge state of all of the cells. In the sustain period of the first subfield, the last sustain signal is supplied to the sustain electrodes Z so that the positive polar (+) wall charges are formed in the scan electrodes Y of the discharge cell in which the sustain discharge is generated and that the negative polar (−) wall charges are formed in the sustain electrodes Z of the discharge cell in which the sustain discharge is generated.

Therefore, although a reset signal that rises to the Vst2 that is a smaller voltage than the Vst1 in the second subfield is supplied to the scan electrodes Y, the wall charge state of the scan electrodes Y and the sustain electrodes Z in which the sustain discharge is generated in the first subfield can be initialized. In addition, in the subfields after the third subfield, as described above, reset signals that rise to the Vst2 that is a smaller voltage than the Vst1 can be supplied to the scan electrodes Y to secure the driving margin of the PDP and to initialize the entire discharge cells by a driving voltage of a low level.

The discharge gas charged in the plasma display device according to the present invention can include Xe in order to improve discharge efficiency. That is, the Xe included in the discharge gas can increase the amount of vacuum ultraviolet (UV) rays generated during discharge. Therefore, the amount of visible rays generated by exciting the vacuum UV rays by the phosphor layers 23 is increased so that the brightness of a displayed image can be improved.

As the Xe mixture ratio of the discharge gas is increased, the discharge efficiency is improved so that the brightness of the displayed image can be improved. However, the voltage of the driving signals to be supplied to the electrodes in order to drive the PDP must be increased.

That is, as a secondary electron emission coefficient is very small so that the Xe mixture ratio of the discharge gas is increased, the amount of secondary electrons emitted from the protective layer 14 during the collision of ions is reduced so that a discharge start voltage is increased. Therefore, the magnitudes of driving voltages for generating stable discharge must be increased.

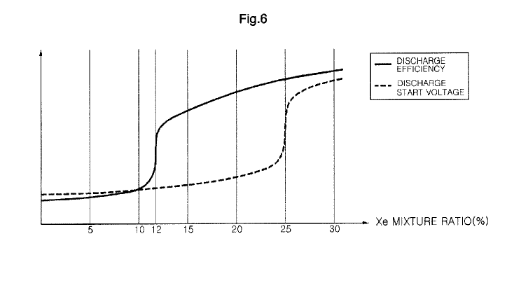

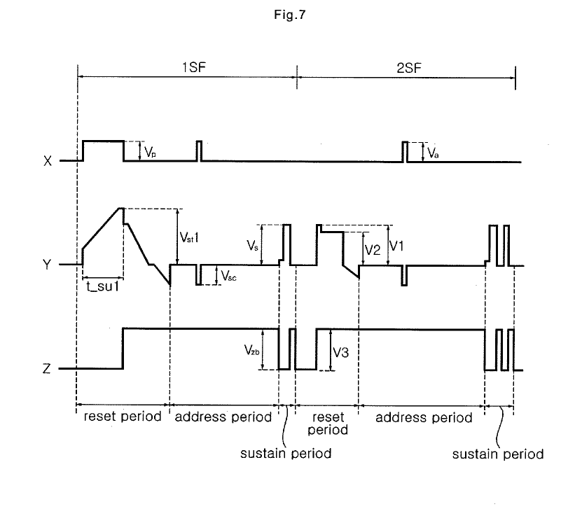

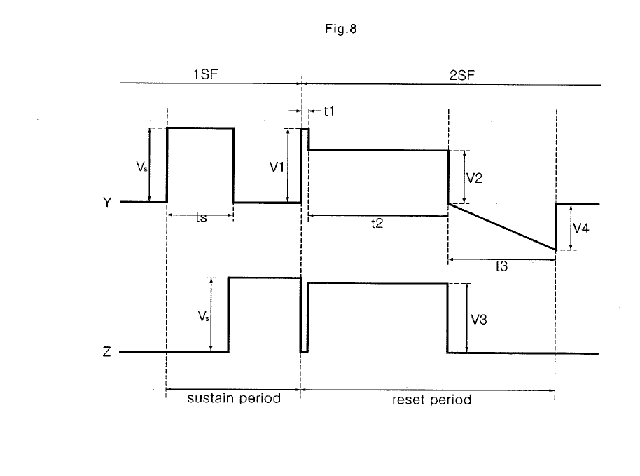

FIG. 6 schematically illustrates the results of experiments on a relationship among the Xe mixture ratio, the discharge efficiency, and the discharge start voltage of a discharge gas.

Referring to FIG. 6, as described above, the discharge efficiency is improved with the increase in the Xe mixture ratio of the discharge gas. However, the discharge start voltage is also increased with the increase in the Xe mixture ratio.

To be specific, the increase in the discharge efficiency is small until the Xe mixture ratio of the discharge gas is 12%. However, the discharge efficiency is rapidly improved at the point where the Xe mixture ratio is 12% and the discharge efficiency sustains a large value when the Xe mixture ratio is no less than 12%.

In addition, the increase in the discharge start voltage is small until the Xe mixture ratio of the discharge gas is 25% so that the stability of discharge is not remarkably affected. However, when the Xe mixture ratio is larger than 25%, the discharge start voltage is rapidly increased so that there is a very high possibility of generating erroneous discharge.

Therefore, in order to improve the discharge efficiency, to improve the brightness of the displayed image, and to prevent the generation of the erroneous discharge with the increase in the discharge start voltage, the Xe mixture ratio of the discharge gas is preferably 12% to 25%.

In addition, when the Xe mixture ratio of the discharge gas is increased as described above in order to improve the brightness of the displayed image, strong discharge is generated between the scan electrodes Y and the address electrodes X in the reset periods to deteriorate the contrast of the displayed image.

Therefore, when the discharge gas having the high Xe mixture ratio is used, in order to reduce the strong discharge between the scan electrodes Y and the address electrodes X, as illustrated in FIG. 5, a positive polar voltage Vp can be supplied to the address electrodes X in the set up period t_su1 of the reset signal.

For example, in the case of the driving signals according to the present invention, as illustrated in FIG. 5, the positive polar voltage Vp is supplied to the address electrodes X in the set up period t_su1 of the reset signal in the first subfield and the positive polar voltage Vp may not be supplied to the address electrodes X in the subfields after the second subfield in which the highest voltage of supplied reset signals is low.

That is, when the discharge gas in which the Xe mixture ratio is high is used, the reset signals having the low highest voltage Vst2 are supplied in the subfields after the second subfield to reduce the generation of the strong discharge between the scan electrodes Y and the address electrodes X and to improve the contrast of the displayed image.

FIGS. 7 to 14 illustrate the waveforms of reset signals according to embodiments of the present invention.

Referring to FIG. 7, as described above, the highest voltage V1 of the reset signal supplied to the scan electrodes Y in the second subfield 2SF is preferably lower than the highest voltage Vst1 of the reset signal supplied in the first subfield 1SF.

After the last sustain signal is supplied to the sustain electrodes Z in the first subfield 1SF, a first positive polar voltage V1 lower than the highest voltage Vst1 of the reset signal supplied in the first subfield 1SF in the reset period of the second subfield 2SF can be supplied to the scan electrodes Y.

When the first positive polar voltage V1 is supplied to the scan electrodes Y, the positive polar (+) wall charges formed in the scan electrodes Y are moved to the discharge spaces of the discharge cells by the last sustain discharge.

After the positive polar (+) wall charges formed in the scan electrodes Y are erased, a third positive polar voltage V3 can be supplied to the sustain electrodes Z. As described above, as the third positive polar voltage V3 is supplied to the sustain electrodes Z, the negative polar (−) wall charges that exist in the discharge spaces are moved to the sustain electrodes Z.

As described above, the amount of the negative polar (−) wall charges formed in the sustain electrodes Z in the reset periods is increased so that a voltage margin for the sustain discharge can be secured and that the generation of the sustain discharge can be stabilized.

In addition, while the positive polar voltage V3 is supplied to the sustain electrodes Z, a second positive polar voltage V2 having a similar voltage level to the level of the third positive polar voltage V3 is supplied to the scan electrodes Y so that the generation of the discharge between the scan electrodes Y and the sustain electrodes Z can be prevented.

In addition, the second and third positive polar voltages V2 and V3 are supplied to the scan electrodes Y so that the negative polar (−) wall charges are formed in the scan electrodes Z and that a wall charge state for the address discharge can be formed.

After the second positive polar voltage V2 is supplied to the scan electrodes Y for a uniform time, a signal whose voltage is gradually reduced can be supplied to the scan electrodes Y.

In order to prevent the strong discharge from being generated between the scan electrodes Y and the sustain electrodes Z by supplying the first positive polar voltage VI to the scan electrodes Y in the front part of the reset signal, the length of the period to which the first positive polar voltage V1 is supplied is preferably as small as possible.

In addition, in order to increase the amount of the negative polar (−) wall charges formed in the sustain electrodes Z, the length of the period to which the second positive polar voltage V1 is supplied is preferably as large as possible.

Therefore, as illustrated in FIG. 7, the length of the period to which the first positive polar voltage V1 is supplied is preferably smaller than the length of the period to which the second positive polar voltage V2 is supplied.

The waveforms of the reset signals described with reference to FIG. 7 can be applied to the subfields after the second subfield.

In addition, in order to erase the positive polar (+) wall charges formed in the scan electrodes Y, a ramp-shaped signal, a low voltage wide pulse, an exponential signal or a half-sinusoidal pulse other than the high voltage narrow pulse illustrated in FIG. 7 can be used.

Hereinafter, the waveforms of the reset signals according to the embodiments of the present invention will be described in detail with reference to FIG. 8.

As described above, the reset signal supplied to the scan electrodes Y in the reset period of the second subfield 2SF can sequentially include a first period to which the positive polar first voltage V1 is supplied, a second period to which the second voltage V2 lower than the first voltage V1 is supplied, and a third period that gradually falls from a reference voltage to a negative polar fourth voltage V4. In the second period, the positive polar second voltage V2 can be supplied to the sustain electrodes Z.

The first voltage V1 supplied to the scan electrodes Y in the first period can be equal to the sustain voltage Vs so that the positive polar (+) wall charges of the scan electrodes Y can be effectively erased and that a driving circuit can be easily formed.

TABLE 1 represents the results of measuring whether address erroneous discharge is generated and whether the strong discharge is generated in the reset period in accordance with a change in the length t1 of the first period.

TABLE 1

| The length (t1) of | The generation of | Power |
|---|---|---|
| the first period | erroneous discharge | consumption |
| 380 ns | ◯ | X |
| 390 ns | ◯ | X |
| 400 ns | ◯ | X |
| 410 ns | X | X |
| 430 ns | X | X |
| 450 ns | X | X |
| 470 ns | X | X |
| 490 ns | X | X |
| 510 ns | X | X |
| 530 ns | X | X |
| 550 ns | X | X |
| 570 ns | X | X |
| 590 ns | X | X |
| 610 ns | X | X |
| 630 ns | X | X |
| 650 ns | X | X |
| 670 ns | X | X |
| 680 ns | X | ◯ |
| 700 ns | X | ◯ |
| 720 ns | X | ◯ |
| 740 ns | X | ◯ |
| 760 ns | X | ◯ |

Referring to the results of measurement of TABLE 1, when the length t1 of the first period to which the first voltage V1 is supplied to the scan electrodes Y is smaller than 410 ns, the positive polar (+) wall charges formed in the scan electrodes Y are not erased so that the erroneous discharge is generated in the address discharge and the sustain discharge.

In addition, when the length t1 of the first period is larger than 670 ns, the strong discharge is generated between the scan electrodes Y and the sustain electrodes Z in the reset period.

Therefore, in order to prevent the strong discharge from being generated by supplying the first voltage V1 to the scan electrodes Y in the first period so that the wall charge state of the scan electrodes Y is effectively initialized without deteriorating the contrast of an image, the length t1 of the first period can be 410 ns to 670 ns.

TABLE 2 represents the results of measuring whether the sustain erroneous discharge is generated in accordance with a change in the length t2 of the second period.

TABLE 2

| The length t2 of the | The generation of the erroneous |
|---|---|
| second period | discharge |
| 15 μs | ◯ |
| 16 μs | ◯ |
| 17 μs | ◯ |
| 18 μs | ◯ |
| 19 μs | X |
| 20 μs | X |
| 21 μs | X |
| 22 μs | X |
| 23 μs | X |
| 24 μs | X |
| 25 μs | X |
| 26 μs | X |
| 27 μs | X |
| 28 μs | X |
| 29 μs | X |
| 30 μs | X |
| 31 μs | X |
| 32 μs | X |
| 33 μs | X |

Referring to TABLE 2, when the length t2 of the second period in which the second voltage V2 is supplied to the scan electrodes Y is no less than 19 μs, the amount of the negative polar (−) wall charges formed in the sustain electrodes Z is increased so that the sustain discharge is stabilized.

In addition, in order to secure the driving margin of the PDP, when the length of the address period, the length of the sustain period, and the length t3 of the third period of the reset signal are considered, the length t2 of the second period is preferably no more than 28 μs.

Therefore, in order to secure the driving margin of the PDP and to stabilize the sustain discharge, the length t2 of the second period can be 19 μs to 28 μs.

When the lengths t1 and t2 of the first and second periods are compared with each other in accordance with the above measurement results, it is noted that the driving margin of the PDP can be secured and that the address discharge and the sustain discharge can be stabilized without deteriorating the contrast of an image when the length t2 of the second period is in the range of 28.4 times to 68.3 times the length t1 of the first period.

In addition, in order not to generate the strong discharge between the scan electrodes Y and the sustain electrodes Z in the first period, the length t1 of the first period is preferably smaller than the width ts of the sustain signal.

When it is assumed that the width ts of the sustain signal is about 2,400 ns to 2,700 ns, the wall charge state of the scan electrodes Y can be effectively initialized without deteriorating the contrast of the image when the width ts of the sustain signal is 3.6 times to 5.5 times the length t1 of the first period.

In order to increase the amount of the negative polar (−) wall charges formed in the sustain electrodes Z in the second period, the third voltage V3 supplied to the sustain electrodes Z can be set to be higher than the second voltage V2 supplied to the scan electrodes Y. The second and third voltages V2 and V3 can have values smaller than the first voltage V1 supplied to the scan electrodes Y in the first period.

To be specific, when the first voltage V1 is set to be excessively higher than the second and third voltages V2 and V3, discharge can be generated between the scan electrodes Y and the address electrodes X. When the first voltage V1 is reduced, the positive polar (+) wall charges formed in the scan electrodes Y may not be erased.

Therefore, in order to prevent the generation of the discharge between the scan electrodes Y and the address electrodes X and to effectively initialize the wall charge state of the scan electrodes Y in the reset period, the first voltage V1 can be 1.2 times to 1.41 times the second voltage V2.

In addition, since the voltage of the scan electrodes Y can he higher than the voltage of the sustain electrodes Z at the point where the first period ends, in order to have the negative polar (−) wall charges formed in the scan electrodes Y and the sustain electrodes Z and to stabilize the address discharge and the sustain discharge, the second voltage V2 supplied to the scan electrodes Y in the second period is preferably 0.89 times to 0.96 times the third voltage V3 supplied to the sustain electrodes Z.

Referring to FIG. 9, in order to facilitate the structure of the driving circuit, the third voltage V3 supplied to the sustain electrodes Z in the second period can be equal to the bias voltage Vzb supplied to the sustain electrodes Z in the address period.

In addition, as illustrated in FIG. 9, the third voltage V3 is continuously supplied to the sustain electrodes Z in the third period where the voltage of the reset signal is gradually reduced so that the loss of the negative polar (−) wall charges formed in the second period can be reduced.

As described above, in order to supply the second voltage V2 to the scan electrodes Y in the second period t2 of the reset signal, a scan driving circuit for supplying the driving signals to the scan electrodes Y can include a power source for supplying the second voltage V2.

The power source for supplying the second voltage V2 can be an additional independent power source or a dependent power source charged from the independent power source included in the scan driving circuit to supply the second voltage V2.

For example, the power source for supplying the second voltage V2 can receive current from a power source for supplying the sustain voltage Vs to supply the second voltage V2 to the scan electrodes Y.

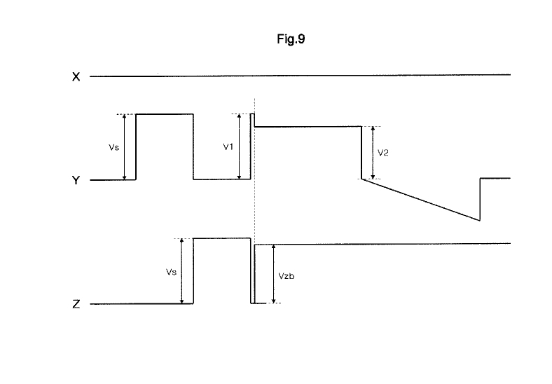

Therefore, as illustrated in FIG. 10, the waveforms of the signals supplied to the scan electrodes Y or the sustain electrodes Z in the part where the first period t1 and the second period t2 of the reset signal start can have similar shapes to resonance waveforms.

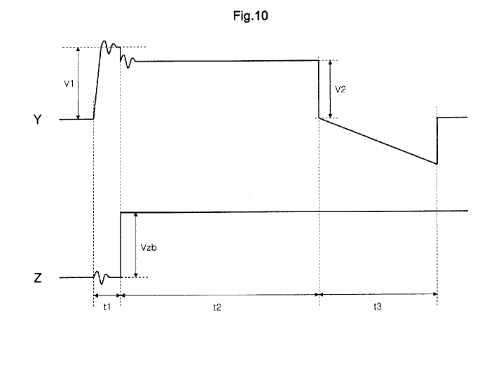

FIGS. 11 to 14 illustrate the waveforms of the driving signals of the PDP according to other embodiments of the present invention. After supplying the reset signals as described with reference to FIGS. 7 to 10, a stabilization signal can be supplied to the scan electrodes Y.

Referring to FIG. 11, by supplying the stabilization signal that rises to a positive polar voltage V4 to the scan electrodes Y between a period in which the reset signal is supplied and the address period, the wall charges of the discharge cell that are not uniformly formed even by supplying the reset signal can be made uniform or the wall charges uniformly formed in the discharge cell can be made firm. Therefore, the stabilization signal makes the wall charges in the discharge cell uniformly distributed.

When the reset signals having the waveforms described with reference to FIGS. 7 TO 10 are supplied to the scan electrodes Y, the amount of the negative polar (−) wall charges formed in the scan electrodes Y can be insufficient. The amount of the negative polar (−) wall charges of the scan electrodes Y can be increased by supplying the stabilization signal to the scan electrodes Y so that the address discharge can be stabilized.

In particular, when the plasma display device is used for a long time, the characteristics of the PDP change so that the phosphor formed in the discharge cell becomes very sensitive to the discharge start voltage. In this case, a positive polar rising signal makes the distribution of the wall charges uniform to be suitable for the characteristics of the phosphor that becomes sensitive to the discharge start voltage so that the erroneous discharge of a brilliant point can be prevented.

In this case, the fourth voltage V4 of the stabilization signal is made equal to the sustain voltage Vs so that an additional power source for supplying the stabilization signal is not provided but a sustain voltage source can be commonly used as the power source for supplying the stabilization signal.

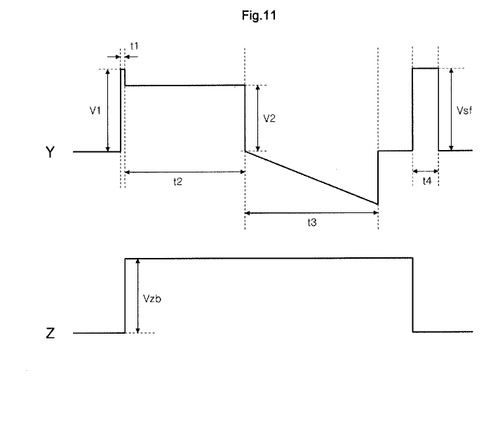

Referring to FIG. 12, the stabilization signal can gradually rise to the highest voltage Vsf.

Since the stabilization signal illustrated in FIG. 12 has a ramp waveform whose voltage is gradually increased, weak discharge is generated by the discharge cells to form the wall charges and the amount of wall charges is increased in the scan electrodes where the amount of the wall charges formed by the reset signals is insufficient so that the address discharge can be stabilized in the address period.

In addition, the stabilization signal gradually reduces the amount of the wall charges in the scan electrodes where the amount of the wall charges formed by the reset signals is excessively large so that the generation of the erroneous discharge of the brilliant point in the address period can be reduced.

In addition, in order for the driving circuit to easily supply the stabilization signal without an additional voltage source, the highest voltage Vsf of the stabilization signal can be equal to the sustain voltage Vs.

The stabilization signal supplied to the scan electrodes Y can include at least two positive polar or negative polar pulses.

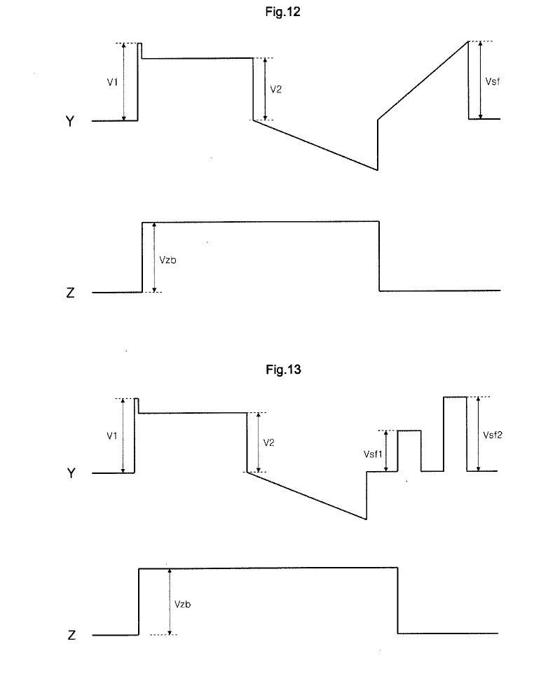

Referring to FIG. 13, the at least two pulses having a positive polar voltage as the stabilization signal can be supplied to the scan electrodes Y and the voltages Vsf1 and Vsf2 of the at least two pulses can be different from each other.

For example, as illustrated in FIG. 13, the voltage Vsf1 of the first supplied pulse can be lower than the sustain voltage Vs and the voltage Vsf2 of the second supplied pulse can be higher than the voltage Vsf1 of the first supplied pulse.

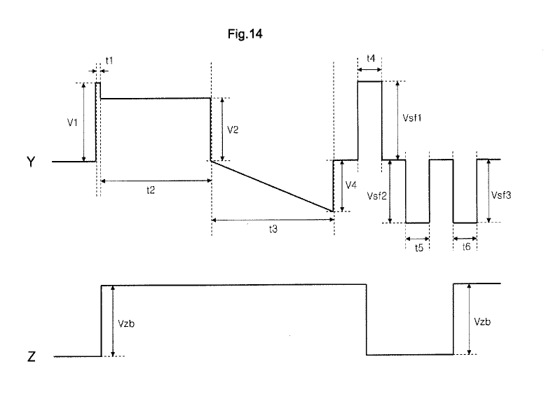

In addition, as illustrated in FIG. 14, the pulse having the positive polar voltage Vsf1 and the pulses having the negative polar voltages Vsf2 and Vsf3 can be sequentially supplied to the scan electrodes Y.

In this case, in order to prevent the amount of the negative polar (−) wall charges formed in the scan electrodes Y from being excessively reduced, as illustrated in FIG. 14, the lowest voltage V4 of the reset signals is preferably higher than the voltages Vsf2 and Vsf3 of the negative polar pulses.

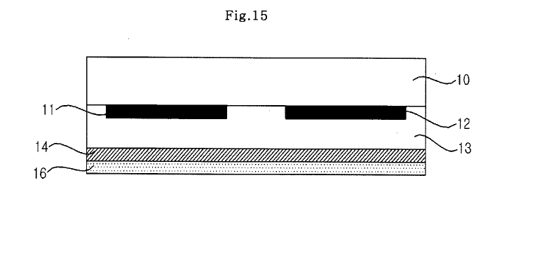

FIG. 15 is a sectional view illustrating the structure of the upper substrate of the PDP according to an embodiment of the present invention.

Referring to FIG. 15, a crystal layer 16 including a material having a large number of secondary electrons emitted when ions emitted from a discharge space collide with the surface and whose surface is damaged less due to the collision of the ions, for example, an MgO crystal can be formed on the protective layer 14 formed of MgO.

When the peaks of light emitted when the ions emitted from the discharge space collide with the surface are compared with each other, the crystal layer 16 can perform emission having a peak in a lower wavelength region than the protective layer 14.

That is, the crystal layer 16 emits light having a peak in a lower wavelength region than the protective layer 14 when the ions emitted from the discharge space collide with the surface to increase the amount of emission of the secondary electrons.

For example, the crystal layer 16 includes a plurality of MgO crystals whose average diameter is no less than 500 Å and the protective layer 14 can consist of MgO particles much smaller than the MgO crystals.

Due to a difference in the size of the MgO crystals, the peak of the light emitted from the crystal layer 16 when the ions emitted from the discharge space collide with the surface can be in a lower wavelength region than the peak of the light emitted from the protective layer 14.

The size of the MgO crystals included in the crystal layer 16 can be determined so that the peak of the light emitted from the crystal layer 16 does not overlap the peak of the light emitted from the protective layer 14 and that light having a lower wavelength region can be emitted from the crystal layer 16.

For example, the peak of the light emitted from the crystal layer 16 when the ions emitted from the discharge space collide with the surface can be positioned in a wavelength region of about 200 nm to 300 nm and the peak of the light emitted from the protective layer 14 can be positioned in a wavelength region of about 300 nm to 400 nm higher than the wavelength region of about 200 nm to 300 nm.

As described above, the protective layer 14 and the crystal layer 16 having different emission peak regions are formed on the upper substrate of the PDP to reduce the discharge start voltage.

According to an embodiment of the present invention, as described with reference to FIG. 15, the crystal layer 16 is formed on the MgO protective layer 14 so that the increase in the discharge start voltage caused by including the Xe in the discharge gas can be compensated for.

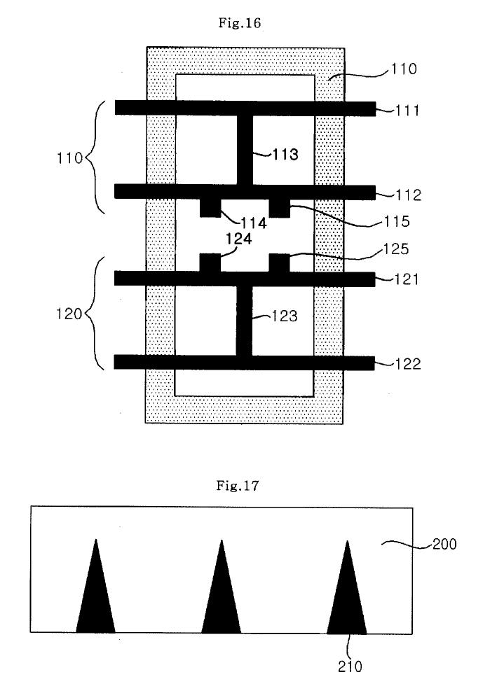

FIG. 16 is a sectional view illustrating the structure of the electrodes of the upper substrate of the PDP according to an embodiment of the present invention.

In the PDP according to an embodiment of the present invention, the scan electrode 11 and the sustain electrode 12 do not include transparent electrodes 11a and 12a and can be formed of one layer formed of one bus electrode.

FIG. 16 is a sectional view illustrating the structure of the upper substrate of the PDP that does not include the transparent electrodes 11a and 12a according to an embodiment of the present invention.

Referring to FIG. 16, a scan electrode 110 and a sustain electrode 120 can respectively include at least two electrode lines 111 and 112 and at least two electrode lines 121 and 122 that cross a discharge cell and two protrusion electrodes 114 and 115 and two protrusion electrodes 124 and 125 that are respectively connected to the electrode lines 112 and 121 closest to the center of the discharge cell and that protrude toward the center of the discharge cell. In addition, the scan electrode 110 and the sustain electrode 120 can further include a connection electrode 113 for connecting the two electrode lines 111 and 112 and a connection electrode 123 for connecting the two electrode lines 121 and 122, respectively.

The electrode lines 111, 112, 121, and 122 cross the discharge cell and are extended toward one direction of the PDP. The electrode lines according to an embodiment of the present invention have a small width in order to improve an aperture ratio.

The protrusion electrodes 114, 115, 124, and 125 can reduce the discharge start voltage when the PDP is driven. The connection electrodes 113 and 123 help the discharge started by the protrusion electrodes 111, 112, 121, and 122 be easily diffused to the electrode lines 111 and 122 remote from the center of the discharge cell.

As described above, when the transparent electrodes 11a and 12a of the PDP are removed, the manufacturing cost of the PDP can be reduced, however, the aperture ratio of the PDP is reduced so that the brightness of the displayed image can be deteriorated.

Therefore, the Xe is included in the discharge gas in a mixture ratio of 12% to 25% with respect to the entire discharge gas so that the reduction in the brightness in accordance with the removal of the transparent electrodes 11a and 12a can be compensated for.

A filter can be provided on the front surface of the PDP according to the present invention and the filter can have a structure in which an external light shielding sheet, an anti-reflection (AR) sheet, a near infrared (NIR) shielding sheet, an electromagnetic interference (EMI) shielding sheet, a diffusion sheet, and an optical characteristic sheet are laminated.

FIG. 17 is a sectional view illustrating the structure of the external light shielding sheet provided on the front surface of the PDP according to an embodiment of the present invention. The external light shielding sheet can include a base unit 200 and a pattern unit 210.

Referring to FIG. 17, the base unit 200 is preferably formed of a transparent plastic material so that light can be smoothly transmitted, for example, a resin based material formed of a UV hardening method and can be formed of a firm glass material in order to improve the effect of protecting the front surface of the PDP.

The pattern unit 210 can be triangular and can have various other shapes. The pattern unit 210 is formed of a material having a darker color than the base unit 200 and is preferably formed of a black material. For example, the pattern unit 210 can be formed of a carbon based material or can be coated with a black dye to maximize the effect of absorbing external light. Hereinafter, between the upper end and the lower end of the pattern unit 210, the one having a larger width is referred to as the lower end of the pattern unit 210.

Since an external light source is commonly positioned on the upper side of the PDP, external light is obliquely incident on the PDP from the upper side to be absorbed into the pattern unit 210.

The above-described external light shielding sheet is positioned on the front surface of the PDP so that a black image can be effectively realized and that the contrast of a bright chamber can be improved. However, the visible rays emitted from the PDP are shielded by the external light shielding sheet so that the brightness of the displayed image can be reduced.

Therefore, the Xe is included in the discharge gas in the mixture ratio of 12% to 25% with respect to the entire discharge gas so that the reduction in the brightness caused by providing the external light shielding sheet on the front surface of the PDP can be compensated for.

In the plasma display device according to the present invention, at least one of H₂, D₂, and T₂ that are hydrogen based isotope gases can be included in the discharge gas. When the hydrogen based isotope gas is included in the discharge gas, since the discharge start voltage at which the discharge starts to be generated is reduced and emission efficiency is improved, power consumption can be reduced and efficiency can be increased.

As the abundance (%) of the hydrogen based isotope gas is increased, the discharge start voltage is exponentially reduced and the discharge start voltage is rapidly reduced when the mixture ratio (%) of the hydrogen based isotope gas is no more than 2%. Meanwhile, when the mixture ratio (%) of the hydrogen based isotope gas is no less than 2%, the degree of the reduction in the discharge start voltage rarely changes.

The emission efficiency is almost similar when the mixture ratio (%) of the hydrogen based isotope gas is no more than 2.0%, however, is rapidly reduced when the mixture ratio (%) of the hydrogen based isotope gas is no less than 2.0%.

Therefore, when the mixture ratio of the hydrogen based isotope gas in the discharge gas is 0.01% to 2.0% lower than the mixture ratio of the Xe, the discharge start voltage can be reduced in a range of not remarkably deteriorating the discharge efficiency of the PDP.

As described above, when the hydrogen based isotope gas is mixed with the discharge gas, the discharge start voltage can be reduced. Therefore, the effect is increased by a long gap structured PDP in which the gap between the scan electrode 11 and the sustain electrode 12 is no less than 80 μm to improve the efficiency. That is, the efficiency is improved as the gap between the scan electrode 11 and the sustain electrode 12 is increased. However, since the discharge start voltage is increased, the discharge start voltage can be reduced using the discharge gas having the above structure.

In addition, in the PDP according to the present invention, the hydrogen based isotope gas of no more than 2.0% is included in the discharge gas and the thickness of the upper dielectric layer 14 is increased to 30 to 100 μm so that power consumption can be reduced. This is because the discharge start voltage is reduced and the emission efficiency is improved by the hydrogen based isotope gas and the thickness of the upper dielectric layer 14 is increased so that the displacement current and the reactive power of the upper substrate 10 are reduced.

According to the present invention having the above structure, in the reset period for initializing the wall charges formed in the electrodes, low voltage small width signals are supplied to the scan electrodes to erase the positive polar wall charges formed in the scan electrodes so that the generation of the brilliant point can be prevented and that the driving margin of the PDP can be secured. In addition, after the wall charges are erased, a positive polar voltage is supplied to the scan electrodes and the sustain electrodes to form the negative polar charges in the discharge space on the electrodes so that a voltage margin for the address discharge and the sustain discharge is secured and that the discharge can be stabilized.

Although embodiments of the present invention have been described with reference to drawings, these are merely illustrative, and those skilled in the art will understand that various modifications and equivalent other embodiments of the present invention are possible. Consequently, the true technical protective scope of the present invention must be determined based on the technical spirit of the appended claims.

What is claimed is:

1. A plasma display device comprising:
a plasma display panel including a plurality of scan electrodes and sustain electrodes formed on an upper substrate and a plurality of address electrodes formed on a lower substrate; and
a driving unit for supplying driving signals to the plurality of electrodes,
wherein a unit frame of the panel is divided into a plurality of subfields to be driven,
wherein a reset signal supplied to the scan electrodes in at least one subfield among the plurality of subfields comprises a first period in which a first voltage is supplied, a second period in which a second voltage lower than the first voltage is supplied, and a third period in which a voltage is gradually reduced, and
wherein a third positive voltage is supplied to the sustain electrodes in the second period.

2. The plasma display device of claim 1, wherein the length of the second period is larger than the length of the first period.

3. The plasma display device of claim 1, wherein the length of the second period is 28.4 times to 68.3 times the length of the first period.

4. The plasma display device of claim 1, wherein a width of sustain signals supplied to the scan electrodes or the sustain electrodes is larger than the length of the first period.

5. The plasma display device of claim 4, wherein the width of the sustain signals is 3.6 times to 5.5 times the length of the first period.

6. The plasma display device of claim 1, wherein the first voltage is higher than the second and third voltages.

7. The plasma display device of claim 1, wherein the first voltage is substantially equal to a sustain voltage.

8. The plasma display device of claim 1, wherein the second voltage is lower than the third voltage.

9. The plasma display device of claim 1, wherein the first voltage is 1.2 times to 1.41 times the second voltage.

10. The plasma display device of claim 1, wherein the second voltage is 0.89 times to 0.96 times the third voltage.

11. The plasma display device of claim 1, wherein the third voltage is supplied to the sustain electrodes in the third period.

12. The plasma display device of claim 1, wherein a discharge gas charged in a discharge space between the upper substrate and the lower substrate comprises Xe of 12% to 25% with respect to the entire discharge gas.

13. The plasma display device of claim 1,
wherein a reset signal supplied to the scan electrodes in a first subfield among the plurality of subfields comprises a set up period that gradually rises to a fourth voltage and a set down period that gradually falls to a fifth voltage, and
wherein a sixth positive polar voltage is supplied to the address electrodes in the set up period.

14. The plasma display device of claim 13,
wherein a reset signal supplied to the scan electrodes in a second subfield sequentially comprises the first, second, and third periods, and
wherein the first voltage supplied in the first period is lower than the fourth voltage.

15. The plasma display device of claim 14, wherein a seventh voltage supplied to the address electrodes in the first period of the second subfield is lower than the sixth voltage.

16. A plasma display device comprising:
a plasma display panel including a plurality of scan electrodes and sustain electrodes formed on an upper substrate and a plurality of address electrodes formed on a lower substrate; and
a driving unit for supplying driving signals to the plurality of electrodes,
wherein a unit frame of the panel is divided into a plurality of subfields to be driven,
wherein a reset signal supplied to the scan electrodes in at least one subfield among the plurality of subfields comprises a first period in which a first voltage is supplied, a second period in which a second voltage lower than the first voltage is supplied, and a third period in which a voltage is gradually reduced,
wherein a fourth positive polar voltage is supplied to the sustain electrodes in the second period, and
wherein a stabilization signal comprising a signal that rises to an eighth positive polar voltage is supplied to the scan electrodes in a period between the third period and an address period.

17. The plasma display device of claim 16, wherein the eighth voltage is higher than the second and third voltages.

18. The plasma display device of claim 16, wherein a length of a period in which the eighth voltage is supplied to the scan electrodes is larger than the length of the first period and is smaller than the length of the second period.

19. The plasma display device of claim 16, wherein the stabilization signal comprises at least one signal that falls to a ninth negative polar voltage.

20. The plasma display device of claim 19, wherein the ninth voltage is lower than a lowest voltage supplied to the scan electrodes in the third period.
